(19) United States
(12) Patent Application Publication
(10) Pub. No.: US 2013/0332227 A1
(43) Pub. Date: Dec. 12, 2013

(54) SYSTEM, METHOD, AND ARTICLE OF MANUFACTURE FOR HOUSEHOLD UNIT ORGANIZATION AND COMMUNICATION

(71) Applicant: Abode360, Inc., San Ramon, CA (US)

(72) Inventors: Khannan Sankaran, San Ramon, CA (US); Ashish Sanan, Fremont, CA (US); Shalesh Jawa, Fremont, CA (US); Pankaj Kalra, Fremont, CA (US)

(21) Appl. No.: 13/912,710

(22) Filed: Jun. 7, 2013

Related U.S. Application Data
(60) Provisional application No. 61/656,524, filed on Jun. 7, 2012.
(60) Provisional application No. 61/665,252, filed on Jun. 27, 2012.

(51) Int. Cl. G06Q 30/02

(52) U.S. Cl. CPC G06Q 30/0201; G06Q 30/0255
USPC 705/7.29

(57) ABSTRACT

A method of, system for, and article of manufacture for organizing and managing a household unit using a communications network. The method may include acquiring information from plural members of a household; acquiring planning information for a household-oriented goal(s); and sharing, with a third party via the network, data and content associated with the household-oriented goal(s) in order to solicit targeted quotes from the third party to accomplish the household-oriented goal(s).

### CROSS-REFERENCE TO RELATED APPLICATIONS

This application claims priority to and the benefit of U.S. Provisional Patent Application Nos. 61/656,524 filed on Jun. 7, 2012 and 61/665,252 filed on Jun. 27, 2012, which are incorporated herein in their entireties by reference.

### TECHNICAL FIELD

In various embodiments, the invention relates to an information management system and, more particularly, to a home information management system having a suite of applications, including a home board and a third-party application store.

### BACKGROUND

Conventional methods of collecting, storing, and retrieving data for individuals are often primarily directed towards collecting and analyzing data corresponding to the individuals. Data associated with home and home-related individuals, assets, documents, pets, various activities of individuals and social relationships may be difficult to acquire or inconsistently acquired. Accordingly, improvements may be made over conventional methods of collecting and analyzing data.

### SUMMARY OF THE INVENTION

A system, method, and article of manufacture for household unit organization are disclosed. In a first aspect, a system for household organization comprising computer memory for storing computer executable instructions and a processing device for executing the instructions are disclosed. In some embodiments, execution of the instructions causes a software platform to collect, store in the computer memory, and use information about members of the household and about individual and group activities of the members of the household to establish a household plan and/or a household goal. Preferably, the software platform is adapted to share data and content associated with each household plan and household goal with a third party, e.g., an advertiser, in order to solicit targeted quotes from the third party to accomplish each household plan and household goal. Optionally, the system further includes a scanning device for uploading a receipt of a purchase into the system. Along with scanning, the system will provide the ability to take pictures and tag the home assets which will simplify the asset entry into the system. Preferably, each household plan and/or household goal may be included in an application programming interface that is shared with a third party for the purpose of soliciting targeted quotes from the third party to accomplish the household plan or a household goal.

In some embodiments, the information about members of the household includes a relationship between members, age, gender, an education level, a type of employment, personal income, savings, investments, health insurance, life insurance, automobile insurance, home insurance, rental insurance, property ownership, recent transactions completed, recent online searches performed, and/or a wish list of items to purchase. In other embodiments, information about individual and group activities is selected from a to-do chore list, a calendar of events, a personal calendar, a text message, and/or an email message. Advantageously, access to the information can be restricted to only discrete, pre-defined users. In still other embodiments, the system is accessible by a mobile device belonging to a member of the household.

In one implementation, the software platform includes an application(s) to track an item such as health and medical history of a member of the household; a health care provider of a member of the household; recurring prescription needs of a member of the household; education of a member of the household; financial planning of a member of the household; estate planning of a member of the household; savings information of a member of the household; investment information of a member of the household; travel planning of a member of the household; vacation planning of a member of the household; shopping preferences of a member of the household; periodic billing creditors of a member of the household; household resource planning; household social networking; and a list of household chores, including assignment of each chore to a member of the household. System will learn the behavior of the household members and eventually trigger alerts and notifications. This “predictive modeling” will be built on top of the data that will be collected over the period of time as users of the household use the system.

In another implementation of the system, the software platform is adapted to selectively provide information about the household plan and/or household goal to a third-party advertiser that transmits target-specific advertisements to the members of the household in furtherance of the plan or goal. In yet another implementation, the software platform includes artificial intelligence to identify spending patterns of members of the household. For example, the artificial intelligence may be able to identify an opportunity to refinance a home mortgage loan, a home equity loan, a business loan, and/or an automobile loan. In still another implementation, the software platform is adapted to collect, store in the computer memory, and use information about electronic devices and appliances within the household.

In a second aspect of the present invention, a method of organizing and managing a household unit via a communications network is disclosed. The method includes acquiring, and thereafter storing in a computer memory, information from each member of a plurality of members of the household; acquiring, and thereafter storing in a computer memory, planning information for a household-oriented goal or plan; and sharing, with a third party (e.g., an advertiser) via the network, data and content associated with each household plan and household goal in order to solicit targeted quotes from the third party to accomplish each household plan and household goal. For example, the method includes providing selected information from the members and selected planning information to a third party and communicating targeted advertisements from the third party to a discrete member(s). Advantageously, access to information about each member can be restricted.

In another embodiment, the method includes receiving operational information from electronic devices and appliances that are adapted to communicate the operational information via the network. For example, the operational information received may include a usage, a readiness, a charge status, a usable life, diagnostic information, and an expected remaining usable life of the electronic device. In one implementation, acquiring information from members includes importing information from a non-member of the household and/or scanning a purchase receipt and uploading the scanned receipt document information.

In a third aspect, an article of manufacture for use in a system for household organization is disclosed. Preferably, computer-readable program portions are embedded on the article of manufacture. The program portions may include instructions for acquiring, and thereafter storing in a computer memory, information from members of a household; acquiring, and thereafter storing in the computer memory, planning information for establishing a household plan and/or a household goal; and sharing, with a third party via a network, data and content associated with each household plan and household goal in order to solicit targeted quotes from the third party to accomplish each household plan and household goal. In some embodiments, the article of manufacture includes instructions for presenting third-party advertisements to a member(s) of the household based on the information from the members and on the planning information. In other embodiments, the article of manufacture also includes instructions for presenting third-party advertisements to at least one member of the household based on the information from the plurality of members of the household and on the planning information.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is an illustration of an embodiment of an initial home screen in accordance with the present invention;

FIG. 2A illustrates an embodiment of a MYHOME home page screen in accordance with the present invention;

FIG. 2B illustrates an embodiment of a weekly calendar of events data entry screen in accordance with the present invention;

FIG. 2C illustrates an embodiment of a daily calendar of events data entry screen in accordance with the present invention;

FIG. 2D illustrates an embodiment of a monthly expense data entry screen in accordance with the present invention;

FIG. 2E illustrates an embodiment of a notes data entry screen in accordance with the present invention;

FIG. 3 illustrates an embodiment of a homepage data entry screen in accordance with the present invention;

FIG. 4 illustrates an embodiment of an application exchange screen in accordance with the present invention;

FIG. 5 illustrates an embodiment of a vault (home-wallet) application data entry screen in accordance with the present invention;

FIG. 6 illustrates an embodiment of a home finance application data entry screen in accordance with the present invention;

FIG. 7 illustrates an embodiment of an assets application data entry screen in accordance with the present invention;

FIG. 8 illustrates an embodiment of a health care application data entry screen in accordance with the present invention;

FIG. 9 illustrates an embodiment of a pet application data entry screen in accordance with the present invention;

FIG. 10 illustrates an embodiment of an insurance application data entry screen in accordance with the present invention;

FIG. 11A illustrates an embodiment of a travel application data entry screen in accordance with the present invention;

FIG. 11B illustrates an embodiment of a travel application summary screen in accordance with the present invention;

FIG. 12 illustrates an embodiment of an education application data entry screen in accordance with the present invention;

FIG. 13 illustrates an embodiment of a home board screen in accordance with the present invention;

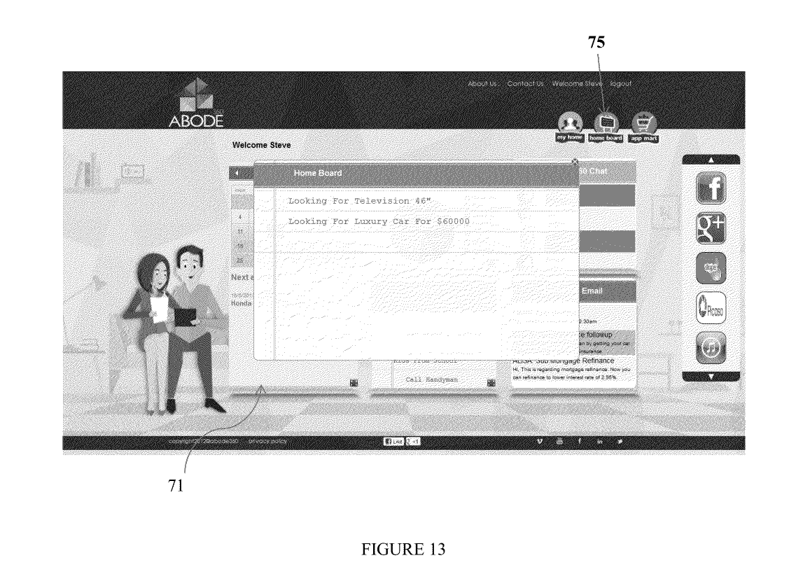

FIG. 14 illustrates an embodiment of a system configured with processes according to some of the embodiments of the present invention;

FIG. 15 is a block diagram of an exemplary system that can be utilized to implement some embodiments of the present invention;

FIG. 16 is an exemplary computer system that may be operated as part of the system and/or method according to some embodiment of the present invention; and

FIG. 17 is a process flow chart illustrating presentation of a targeted advertisement based on personal member information and planning information in accordance with some embodiments of the present invention.

### DETAILED DESCRIPTION OF THE INVENTION

Disclosed are a system, method, and article of manufacture for household unit organization and communication. Although the present embodiments have been described with reference to specific examples, it will be evident that various modifications and changes may be made to these embodiments without departing from the broader spirit and scope of the invention.

Reference throughout this specification to “one embodiment,” “an embodiment” or similar language means that a particular feature, structure or characteristic described in connection with the embodiment is included in at least one embodiment of the present invention. Thus, appearances of the phrases “in one embodiment,” “in an embodiment,” and similar language throughout this specification may, but do not necessarily, refer to the same embodiment.

Furthermore, the described features, structures or characteristics of the invention may be combined in any suitable manner in one or more embodiments. In the following description, numerous specific details are provided, such as examples of programming software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic or effect to one or more steps, or portions thereof, of the illustrated method. Additionally, the format and symbols employed are provided to explain the logical steps of the method and are understood not to limit the scope of the method. Furthermore, although various arrow types and line types may be employed in the flow chart diagrams, the arrow and line types are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Unlike conventional applications or software that collect information only about individuals or household goods, some of the embodiments described below include a software platform or suite that includes one or more of the following characteristics or functions:
1. A software platform that collects, stores, and retrieves information about multiple, and potentially all individuals in a household.
2. A software platform that collects, stores, and retrieves information about all individuals' activities in a household, and that, further, facilitates coordination of and between the individuals, jointly and severally, e.g., using—but not being limited to—a to-do list, a shopping list, a calendar of events, an alert, and a note.
3. A software platform that collects, stores, and retrieves information about one or more, or potentially all possessions, articles, assets, and goods in a household, and that, further, keeps track of their periodic or scheduled maintenance.
4. A software platform that collects, stores, and retrieves information about one or more, and potentially all, pets in a household, and that, further, keeps track of their maintenance, health care, and growth.
5. A software platform that uses “analytics” extensively to analyze some or all of the collected data and to provide meaningful analysis through graphs, charts, and/or dashboards to the users, who are the individuals in the household.
6. A software platform that includes an “exchange” place for third-party vendors at which the third-party vendors can develop software applications (“apps”) and deploy them for the home users.
7. A software platform that includes a “social” element that treats a home as a “nodal” center for social interaction.
8. A software platform that may run—at least in part—on the cloud, and may be accessible via the Internet and/or by mobile devices and via other networks, e.g., a local area network (LAN), wide area network (WAN), and the like.
9. A software platform that enables individuals in a home to establish goals and plans and/or that tracks various home activities such as financial matters, health care, education, and so forth.
10. Data stored in connection with an established plan may be provided to and used by advertisers to target specific advertisements to the home. For example, home members might be planning a vacation to Hawaii, hence, advertisers associated with providing air travel, cruises, accommodations, cars, tours or travel packages may receive this information from which discounts, directed advertisements, and/or targeted price quotes may be sent to home members.
11. Each home may include a unique email identification, which may be used as a replacement for traditional “paper mail advertisement” that clutters our mail boxes. This is an “ecological savings” of potentially huge magnitude.
12. A software platform having Artificial Intelligence (AI) and that builds intelligence on top of the home-related data available and presented to the users. For example, the system may learn about the household unit's activities, type of profession for the head of the household, and the activity patterns of members of the household who may be attending school. Using these data, the system may provide intelligent suggestions such as when to replace a certain asset or may transmit savings or investment alerts around pay day or around tax season. The AI portion of the system may also be adapted to learn about the spending/buying patterns of household members and, moreover, to provide intelligent choices or to display relevant advertisements. The system also may track mortgage and/or other loan rates and may be adapted to prompt the head of the household when to consider refinancing the household's primary residence, other investments, auto loans, and so forth.

In some embodiments, the system assists household units such as couples and families to organize household data and to improve data collection, analysis, and interpretation of household data. “Families” may include husband and wife, parent and child, grandparents, uncles, aunts, cousins, pets, or others. The system may also be used by individuals or groups whose members are unrelated by blood or marriage but who wish to share personal information and/or to make group planning decisions, such as roommates, teammates, fraternity brothers, sorority sisters, friends or members of a social group, and the like. The household unit may be composed of persons, animals, and/or plants that are located at the same or at multiple residences.

During registration and data entry, each members of a household unit may be identified along with the relationships between members, such as parent, child, sibling, pet, spouse, grandparent, cousin, friend, roommate, and the like. Other demographic data on each member may also be acquired during registration, such as education status, career, place of employment, income, and property ownership. Defining familial relationships along with identifying the household members may assist the system with providing targeted advertisements to the household unit that may be relevant, timely, and based on information that specifically pertains to the users.

After registration, the system may continue to receive ongoing updates regarding transactions in which members of the household unit are involved, such as online searches, purchases, and wish list generation for consumer items such as televisions, motor vehicles, electronic equipment, furniture, food, and other items. Such information may be received directly from, i.e., input by, the members of the household unit or indirectly from banks, stores, credit card companies, credit monitoring services, financial management software, tax preparation software, wedding planning software, online stores, and/or social networks for which members of the household unit may provide login information. The system may also receive information, e.g., current usage, readiness, charge status, and expected remaining usable life, from electronic devices that are configured to communicate with the system. These electronic devices may be integrated into household appliances (such as refrigerators, ranges, ovens, stoves, washers, dryers, dishwashers, water heaters, boilers, heating units, air conditioning units, and the like), thermostats, utility meters, solar panels, room occupancy sensors, vehicle electronics, personal computers, laptop computers, tablet computers, smartphones, mp3 players, and the like.

The system also may assist with or be notified regarding the household unit's plans for various life events for the members of the household unit, such as vacations, job searches, parenting, marriage, private or public schools, college educations, graduations, home purchases, car purchases or leases, etc. The system may further be aware of health, vehicle, and household insurance information that include existing policies or insurance needs. Medication prescriptions, dental and medical visits, immunization records, and medical history for each member of the household unit may also be stored as data.

In return for providing detailed personal information and family data, the system may be able to provide users with a central location and access point for an entire family's health, financial, and/or other data. Advantageously, these data may be accessed via the Internet or World Wide Web even when a member of the household unit is traveling. In addition, the system may be able to provide discounts, reminders, and recommendations that are relevant to the plans of the household unit as a whole or individually. For example, the system may be aware of a user's interest in purchasing a BMW automobile based on explicit planning requests, emails to dealerships, online search requests, and/or GPS determined visits by a user to a BMW dealership. As a result, targeted advertisements or special offers for BMW automobiles from local dealerships may be provided to the household unit.

In another example, the system may be aware of the current motor vehicles, televisions, computers, and so forth owned by the household unit based on purchase and/or use records. As the items approach the end of their useful life, targeted advertisements for replacement products may be provided to the household unit. The system may also be made aware of the date and time of purchases of common household goods (e.g., soap, paper towels, toilet paper, shampoo, detergent, laundry soap, and so forth); of perishable food items (e.g., butter, bread, milk, juice, eggs, and the like); and/or of household staple food items (e.g., peanut butter, mayonnaise, jams, jellies, condiments, breakfast cereals, salt, pepper, spices, and so forth) that require periodic replacement. With these data, the system may provide the household unit with targeted advertisements from local groceries or supermarkets and/or discount coupons from producers and manufacturers for replacement of those items. The targeted advertisements can be based on a known or estimated expiration date; based on historic usage and depletion of the household unit; or based on expected usage statistics for similar items by people in similar demographic categories. For food items, the system may provide a reminder to dispose of food after an expected expiration date and/or may generate a proposed shopping list for replacement of the same items. In locations where grocery delivery is provided, the system may prepare a proposed delivery request based on the expected times when members of the household unit are typically at home.

The system may also be able to provide assistance with warranty requests by storing purchase information, warranty registration, purchase location, and contact information for the manufacturer. The system may further be capable of receiving diagnostic information that indicates an impending problem, such as equipment or electronic failure or a need to replace a filter, and may relay the information to the household unit.

The system may be configured to determine when a user is pregnant based on related purchases, and may provide discounts at stores in the household unit's vicinity.

The system may also be aware of when a household unit is planning to go on vacation based on online search data and/or on planning requests input by a member of the household. The system may also be aware of a household unit's children, which may allow the system to predict when a vacation will take place or be planned for based on an awareness of when local or regional schools typically permit vacations such as spring, winter, and summer break.

Through coordination of information from multiple sources, the system may assist with tracking information that would otherwise require multiple logins for each service, such as warranty registrations, banks, credit card companies, financial management software, credit score and award tracking software, social networks, alumni networks, telephone companies, utility companies, cable and online video providers, health insurance companies, and the like. The system may further be able to share such information between different, trusted individuals that are members of the same household unit, such as parents, guardians, and children. The information may be shared with one or more members based on a hierarchy. For example, parents may be able to access their children's records while the children are young, but as the children age, parental access to certain data may become more restricted. Children, on the other hand, may be restricted from accessing their parents' private financial data. Alternatively, children who are responsible for aging parents may be able to access their parents' financial information, while the aging parents' access to the other family members' data may be restricted. Access to an individual's data may be granted or denied by the individual whose information is to be shared or it may be controlled by a primary user, i.e., a head of household, who supervises and/or creates accounts for others.

The system may include functionality for Home Resources Planning (HRP), Home Social, and HomeXchange. HRP may provide transactional, analytical, and/or alert capabilities through modules such as Health, Finance, Pets, Assets, etc. HRP may be analogous to SAP for enterprises. Home Social may provide information and photo sharing and chat functions for home groups, as opposed to individuals, and may be analogous to Facebook's functions for individuals. HomeXchange may provide access to third party created applications, and may be analogous to an app store for iPhones. Additional information regarding the appearance and operation of some embodiments of the system, method, and article of manufacture are below, and discuss their relation to the figures.

One aspect of the present invention provides a system with a single point-of-access to view, manage, and edit household unit information for a household having plural members. Advantageously, these data are accessible at any time and from anywhere using a local or a remote electronic device having a processor and a Web-enabled browser. Use of the system may require an initial online enrolment process in which a first household user enters prescribed personal information, e.g., first and last name, date of birth, email address, postal address, and the like, and selects a username and login password. At some point, personal information of other members of the household unit may be added, including the phone number of each member of the household unit to permit the system to provide discrete alerts, e.g., via text message, email, or voice message, and the like, to one or more members of a household unit.

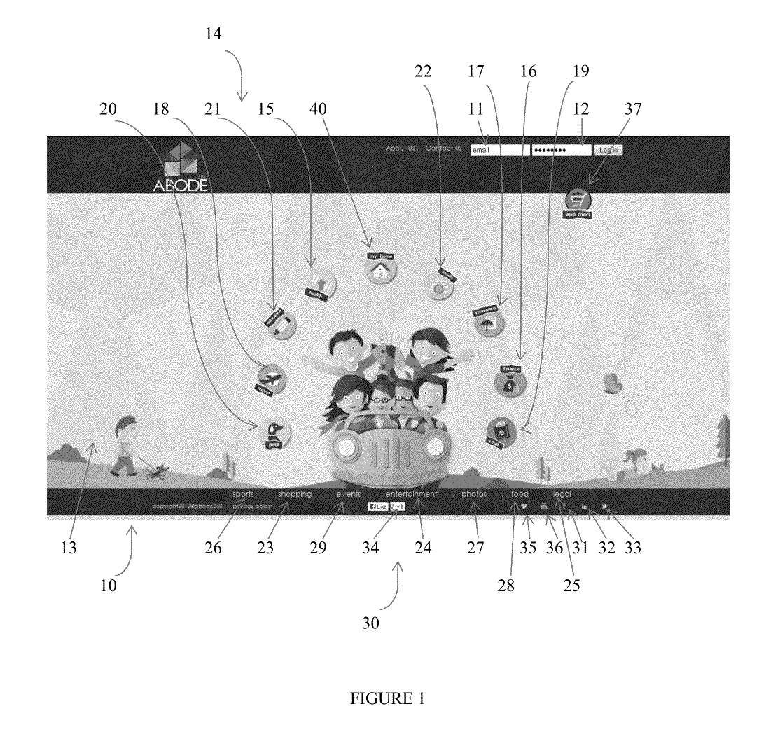

With login completed, the user's graphical user interface (GUI) displays an initial home screen portal from which the user can navigate to other system pages and screens. FIG. 1 shows an illustrative embodiment of an initial home screen 10. The initial home screen 10 includes areas for entering a username 11 and login password 12 for the household unit account, which may provide access to a shared household unit account. Each member of the household unit may generate his/her own account name and password, which provide him/her access to his/her own data, which may be shared with or restricted from other members of the household unit.

The initial home screen 10 includes a user customization field 13, here illustrated as having a circular arrangement about an image of a family. The user customization field 13 may permit a user to add and/or remove modules from their respective primary user interfaces, e.g., their personal home screen. The initial home screen 10 may include images 14 and/or text 30 representing available modules for different categories of information that the system may acquire and to help manage for the household unit. For illustrative purposes only, some examples of different modules having images 14 include: health 15, finance 16, insurance 17, travel 18, a wallet or vault 19, pets 20, education 21, and personal assets 22. For illustrative purposes only, some examples of different modules represented by text 30 include: shopping 23, entertainment 24, legal 25, sports 26, photographs 27, food 28, and events 29. To add modules to a household unit account, the user may drag-and-drop, e.g., using a mouse device, an image 14 or text 30 corresponding to the desired module on the initial home screen 10 into the user customization field 13. The initial home screen 10 may further provide options for sharing the web application with others via a social web site, e.g., Facebook 31, LinkedIn 32, twitter, 33, Google+ 34, vimeo 35, YouTube 36, and the like.

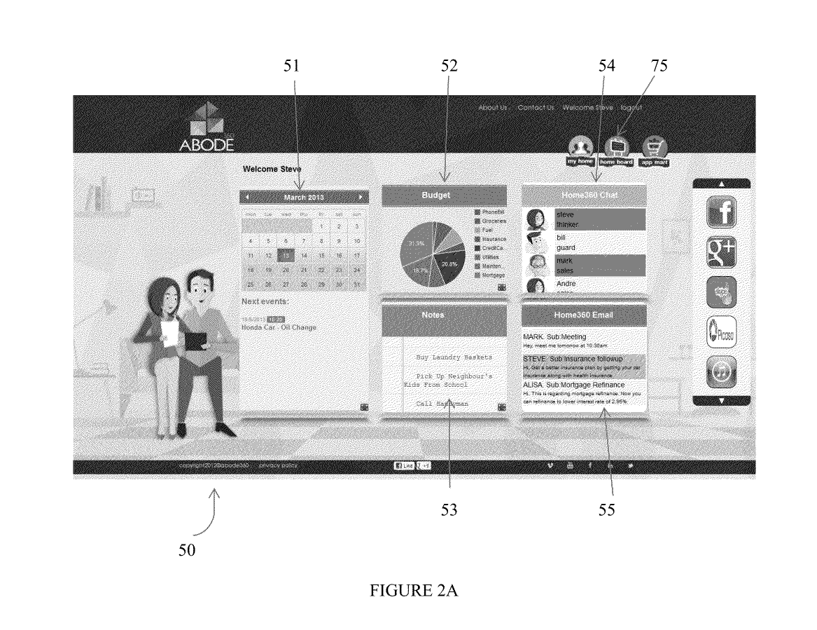

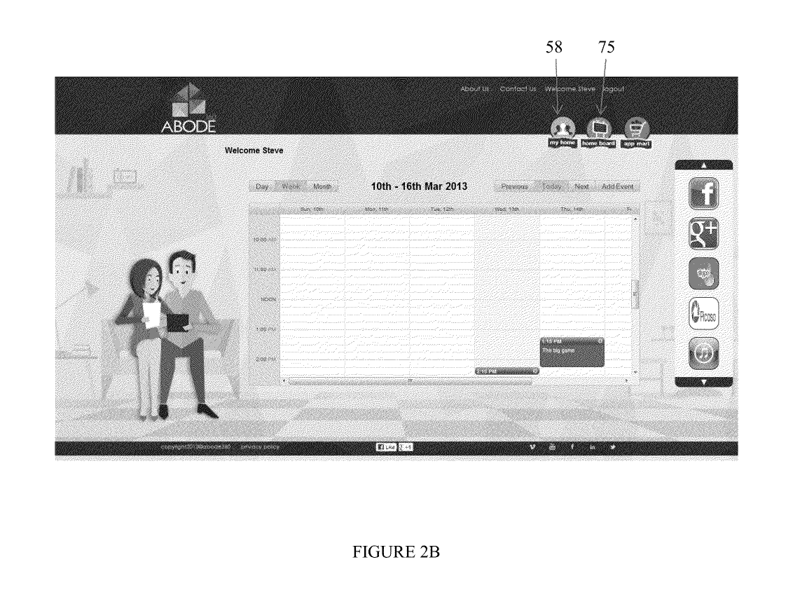

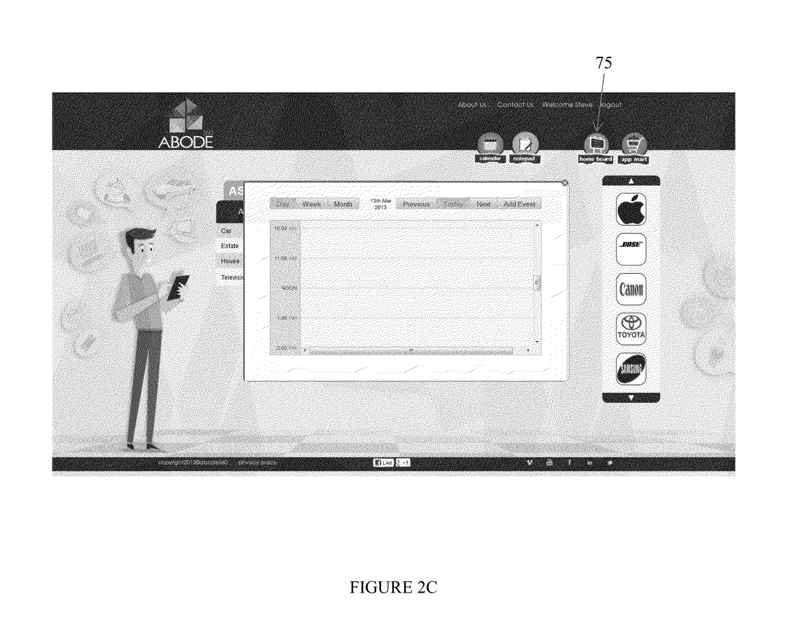

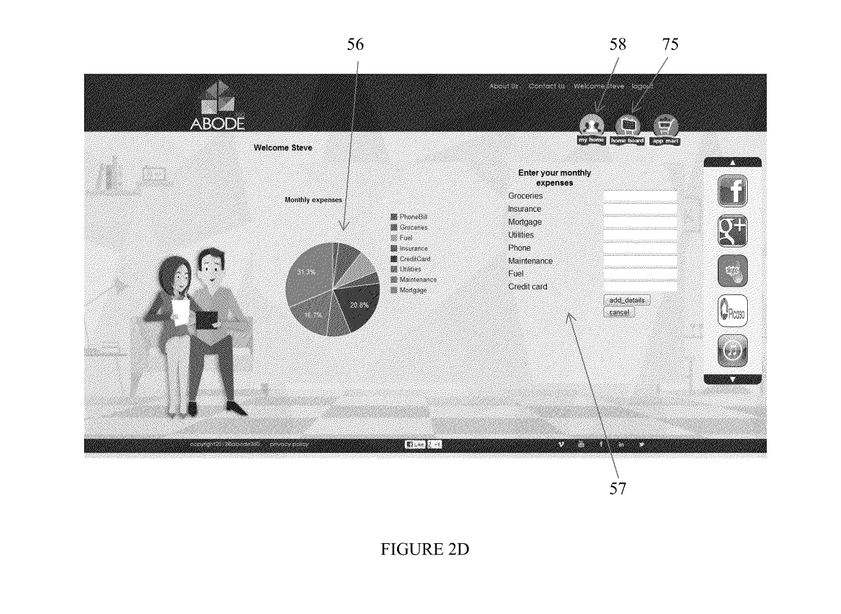

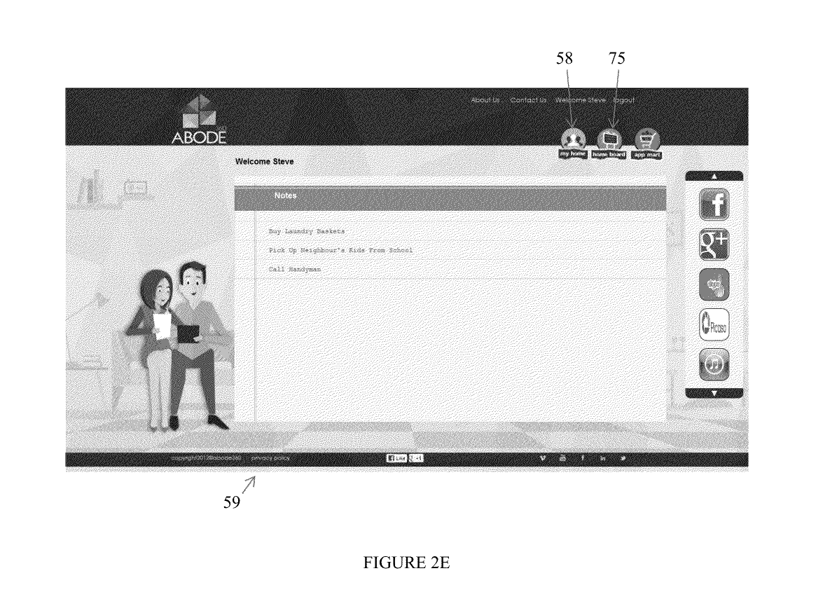

Among the images 14 on the initial home screen 10 can be a homepage icon 40 that provides a link to each user's personalized home page. By clicking on the homepage icon 40, the user's homepage dashboard is displayed. FIG. 2A shows an illustrative embodiment of a customized home page (“MYHOME”) dashboard 50. For illustrative purpose only, the user's MYHOME dashboard 50 displays images of the user's calendar of events 51, monthly budget 52, and notes 53, which provide quick links to, respectively, a calendar screen (FIG. 2B and FIG. 2C), a budget screen (FIG. 2D), or a notes screen (FIG. 2E). Optionally, the MYHOME dashboard 50 may also include quick links to a household chat room application 54 and/or a household email application 55.

Referring to FIG. 2B, after selecting, i.e., clicking on, the calendar of events image 51 on the dashboard 50, the home-calendar application is called, which enables the user to view an image of a monthly, a weekly, and/or a daily calendar of events. FIG. 2C shows an illustrative embodiment of an input screen for adding personal and household calendar data. The home-calendar application forms a central part of the home activities and permits members of a household unit to plan collective activities and coordinate individual schedules and, moreover, to see at a glance daily, weekly, and monthly individual and group activities. In one aspect of the invention, the home-calendar application may be adapted to automatically send email and/or text alerts to members of a household unit, e.g., to their individual mobile devices, based on the calendared activities. Advantageously, the calendar notes application may be accessed from any page or screen. When completed, the user may return to MYHOME dashboard 50 by selecting, i.e., clicking on, a MYHOME icon 58 (depicted in FIG. 2B), which provides a quick link back to the MYHOME dashboard 50.

Referring to FIG. 2D, after selecting, i.e., clicking on, the monthly budget image 52 on the dashboard 50, the budget application is called, which enables a user to view household historical monthly expenses 56, e.g., shown in a pie chart or bar graph format, and to input details about current expenses 57. When completed, the user may return to MYHOME dashboard 50 by selecting, i.e., clicking on, a MYHOME icon 58, which provides a quick link back to the MYHOME dashboard 50.

Referring to FIG. 2E, after selecting, i.e., clicking on, the notes screen 53 on the dashboard 50, the notes application is called, which enables the user to view an image of personal and/or household notes 59, which will be discussed in greater detail below. Advantageously, the notes application may be accessed from practically any page or screen. When completed, the user may return to MYHOME dashboard 50 by selecting, i.e., clicking on, a MYHOME icon 58, which provides a quick link back to the MYHOME dashboard 50.

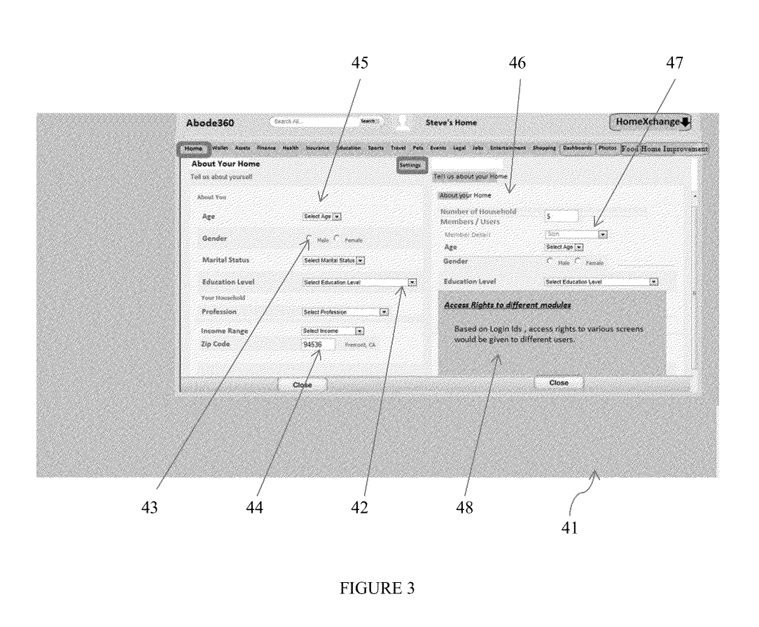

Referring to FIG. 3, there is shown an embodiment of a settings screen 41. The settings screen 41 may be used to set up user accounts and to establish roles and relationships for all the members of a household unit and/or for all persons who live in a home, and/or for persons who are otherwise socially or professionally associated with each other. The settings screen 41 may be used to provide access, read, and/or write privileges to different users.

The settings screen 41 may be accessed when a Home tab 40 (FIG. 1) is selected, i.e., clicked on, on the initial home page 10. Once the Home tab 40 is selected, a settings interface application is called, which enables the user to view the settings screen 41. The settings screen 41 may provide, for example, options for a user to provide personal information via drop down menus 42, radio buttons 43, and/or data entry fields 44. The personal information 45 requested on the settings screen 41 may include age, gender, marital status, education level, profession, personal income range, and zip code. The settings screen 41 may request additional information such as household information 46 that may include, for example, the number of household members/users, an age, gender, and education level for each as well as a relationship to the primary user 47. Additional details may include access rights 48 for other modules.

Advantageously, to avoid hours of tedious manual data entry the system can be based on a library of data entry templates that minimizes the portion of the data that the user must physically enter with respect to the portion of the data that can be gathered from other sources, e.g., using the portion that the user has input. For example, a user may just give his home address, the system defaults the number of bedrooms and bath in the house. Based on the number of bedrooms and bathrooms the system defaults a list of home inventory items like TV, Refrigerator, Washing machine, Beds, Sofa etc. Along with the list of items the approximate value is defaulted as well. The user can modify the data displayed. For example, a user may simply enter that he/she owns a 2008 Volvo XC90 automobile, relying on an application in the system to search for recommended scheduled maintenance events, e.g., by searching the manufacturer's Web site, and to populate appropriate scheduled maintenance data fields associated with the automobile.

Alternatively, users may manually import data from service and/or product providers, such as banks, credit cards, financial management software, healthcare providers, schools, and so forth. Additionally, the system may also be capable of scanning receipts or other purchase documents, e.g., using a scanning device in conjunction with a scanning application associated with a mobile electronic devices. The recorded receipts and/or other purchase documents may then be uploaded into the memory storage of the system. In some embodiments, however, manual data entry may still be used in addition or as an alternative to importing or scanning data.

Furthermore, email receipts and/or social media messages that are transmitted and received in an HTML and/or Text format can be parsed and stored in the database.

As previously mentioned, the homepage screen 10 (FIG. 1) and/or the MYHOME dashboard 50 (FIG. 2A) may include a link(s) to a home-social application(s), which enables social networking activities and/or chat capabilities. The chat capability may include an internal chat room 54 for exchange of messages between members of the household unit. Social network applications, e.g., Facebook 31, LinkedIn 32, Twitter 33, Google+ 34, Vimeo 35, YouTube 36, and so forth, may be embedded in the platform of the system to permit access to existing social networks.

The homepage screen 10 may further include a to-do list (not shown), which permits household unit tasks to be assigned to various users. The system is adapted to provide relevant alerts to household unit members with assigned tasks, e.g., via their mobile device, and, upon completion, the users can update the to-do list of the homepage screen 10, e.g., using their mobile devices.

The homepage screen 10 also may include home-analytics, which can have functionality based on the user's choice of modules. For example, home-analytics may be adapted to provide graphs and/or reports across various tabs, such as assets, finance, health, etc. The system may then compare actual data with goals set by a user, with standardized data, and/or with externally-obtained data. For example, a user of the system may establish a savings goal. Pursuant to that goal, the system may track weekly or monthly expenses for the user and may send out periodic alerts regarding the user's progress towards the goal. Based on the alerts, the user can modify his/her behavior to reach the savings goal. If the user did not specify a goal, the system may recommend and propose a savings goal that the system has based on a comparison of the user's actual spending with national savings data.

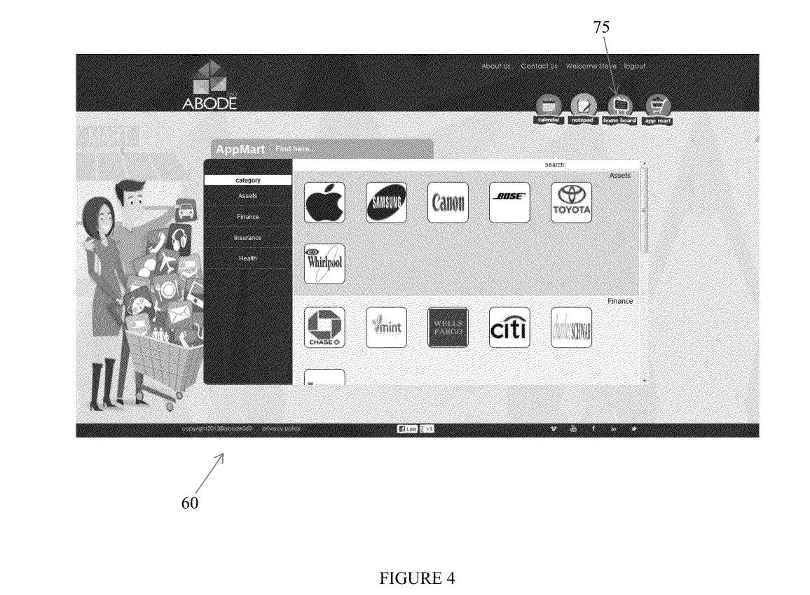

FIG. 4 illustrates an embodiment of a screen 60 for an exchange application, which can be accessed by selecting, e.g., clicking on, an app market icon 37 that may be embedded on the initial home screen 10 and/or the MYHOME dashboard 50. The exchange application may be used to search for, preview, and select applications for household unit use from a myriad of available applications. Thus, in addition to being adapted to run a plurality of applications from a variety of sources, the system, via the exchange application, provides a marketplace for third-party/vendor created applications. The exchange screen 60 may be formatted to be similar in operation to the Appstore for iPhones® and other Apple® products and may include applications in a variety of fields, such as assets management, finances, insurance, health, and so forth. Advantageously, desired applications may be dragged and dropped into the system and may automatically be implemented in the system.

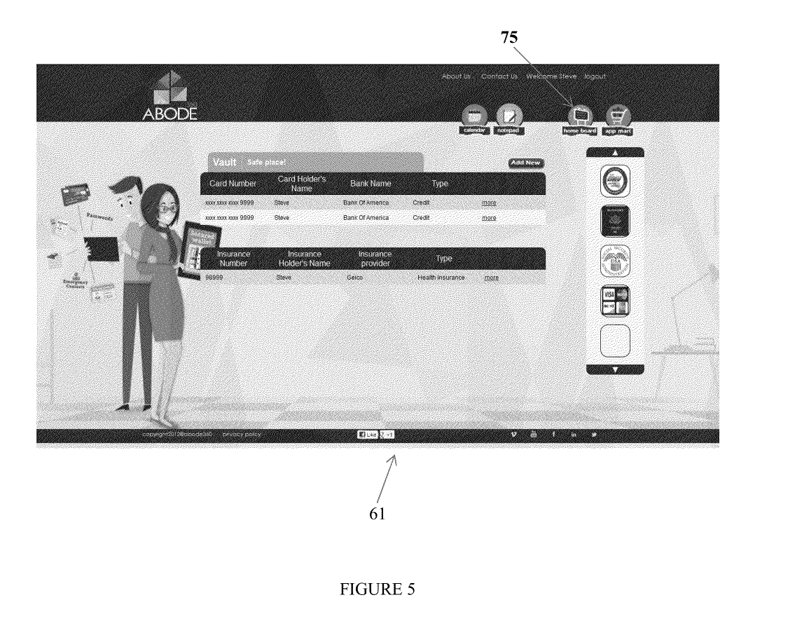

FIG. 5 illustrates an embodiment of a screen 61 for a home vault, i.e., a home-wallet, application, which can be accessed by selecting, e.g., clicking on, the vault icon 19 that may be embedded on the initial home screen 10. The vault application may be used to store critical and emergency information on each member of the household unit. The data may be easily accessed, e.g., via the cloud, using mobile devices, laptops, or desktops that are in communication with the Internet. The information stored in the home-wallet may relate to credit card numbers, expiration dates, and security keys, passport numbers, driver's license numbers, blood groups, insurance policy numbers, emergency contact information, vehicle VIN numbers, vehicle insurance policies, and so forth.

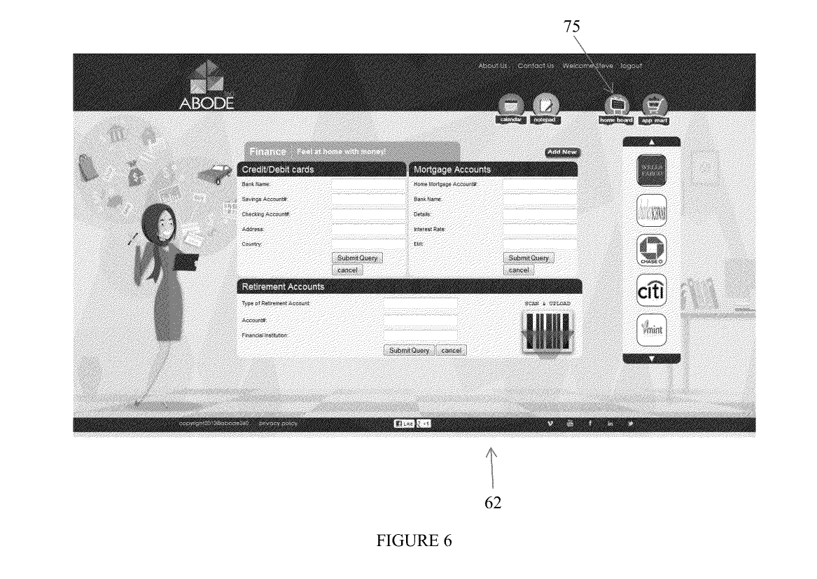

FIG. 6 illustrates an embodiment of a screen 62 for a home-finance application, which can be accessed by selecting, e.g., clicking on, a finance icon 16 that may be embedded on the initial home screen 10. The home-finance application may be used to, inter alia, store bank and investment information. Advantageously, household unit members may enter their own data in the data entry fields of the home-finance screen 62 or may use third-party financial software such as Mint®, e.g. via the screen 60 of the exchange application.

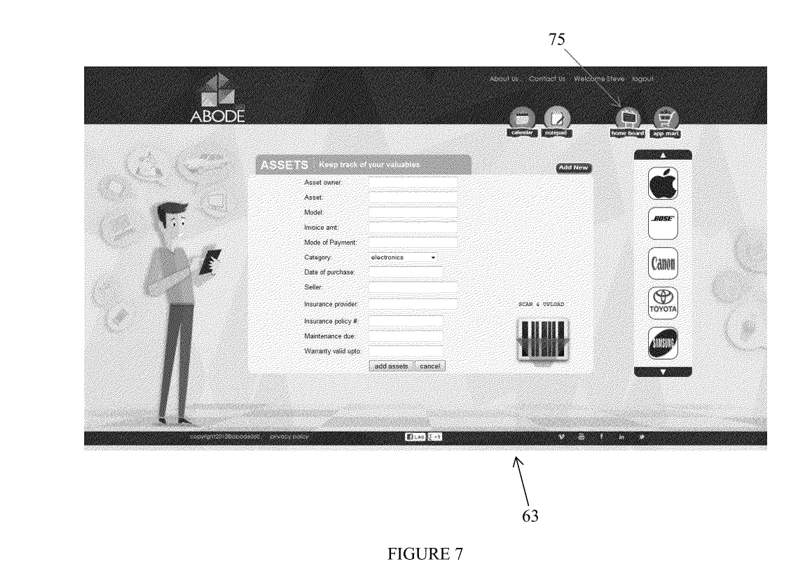

FIG. 7 illustrates an embodiment of a screen 63 for a household unit assets application, which can be accessed by selecting, e.g., clicking on, an assets icon 22 that may be embedded on the initial home screen 10. The assets application may store data on the assets of the household unit, such as estimated value, purchase date, value at time of purchase, warranty information, and so forth. Assets may include real property and personal property such as appliances, e.g., refrigerators, washing machines, dryers, dishwashers, stoves, ranges, ovens, and the like, furniture, electronic equipment, e.g., microwave ovens, toaster ovens, fans/lights, air conditioners, processing devices, electronic gadgets, music systems, televisions, and the like, motor vehicles, bicycles, boats, and so forth. Advantageously, the system is adapted to transmit timely alerts or other messages pertaining to scheduled or recommended maintenance, warranty expiration, loan payment deadlines, movement outside a designated household area, and the like. For example, third-party statistics may indicate that the useful life of a flat-screen television is generally between four and six years after purchase. Accordingly, the assets application of the system may be configured to provide an alert for replacement of the same, starting at or near the fourth anniversary of its purchase. Furthermore, third-party vendors of flat-screen televisions would be provided with said information for the purpose of providing targeted quotes or discounts for flat-screen televisions to the household unit. In another example, the assets application may be adapted to provide an alert for scheduled motor vehicle maintenance, e.g., tire rotation, oil change, fuel filter replacements, air filter replacement, and the like.

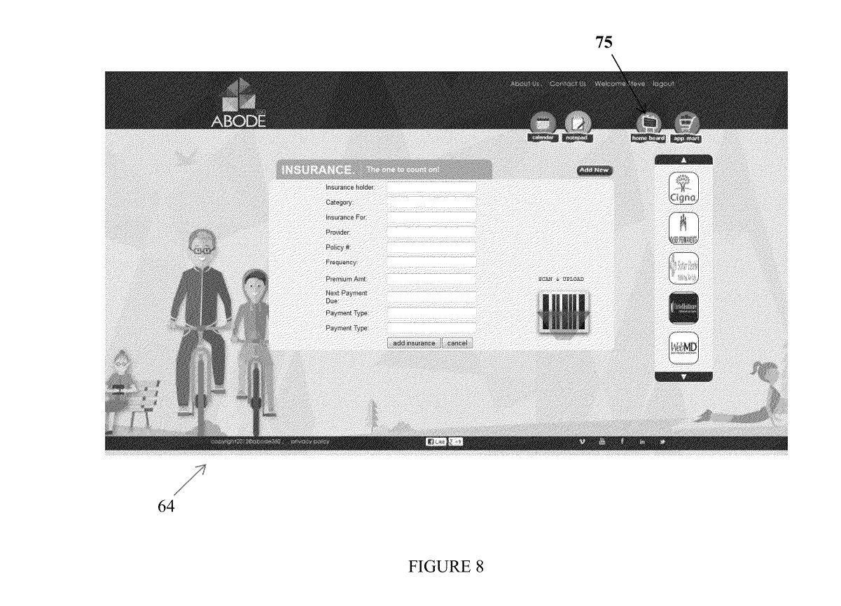

FIG. 8 illustrates an embodiment of a screen 64 for a health application, which can be accessed by selecting, e.g., clicking on, a health icon 15 that may be embedded on the initial home screen 10. The health application may be adapted to store health-related data, e.g., primary care physicians, OB/GYNs, optometrists, specialists, prescribed medications, immunization records, health care proxies, age, height and weight, Medicare/Medicaid information for each individual member as well as health insurance provider, membership/subscriber number, health insurance premiums and date(s) due, dental insurances provider, membership/subscriber number, dental insurance premiums and date(s) due, health club memberships, health club dues and date(s) due, health savings account information, flexible spending account information, and so forth for the household unit. Health information may be accessible by all members of the household unit, or it may be accessible only to particular users, such as parents of children. Advantageously, data may be entered into appropriate data entry fields of the health screen manually or may be imported from existing healthcare providers via the exchange application of the system, and/or imported from existing primary care physician and/or healthcare provider accounts. The health application may be used to establish health goals, e.g., weight loss, to quit smoking, and the like. Moreover, using the stored data, the health application may be adapted to provide discrete household unit members with health-related alerts and other reminder messages, e.g., to refill a prescription, to donate blood, to schedule an annual physical, to schedule a dental cleaning and check-up, to re-schedule a canceled appointment, and so forth, which may be tracked, e.g., through the notes 53 or email application 55 displayed on the MYHOME dashboard 50.

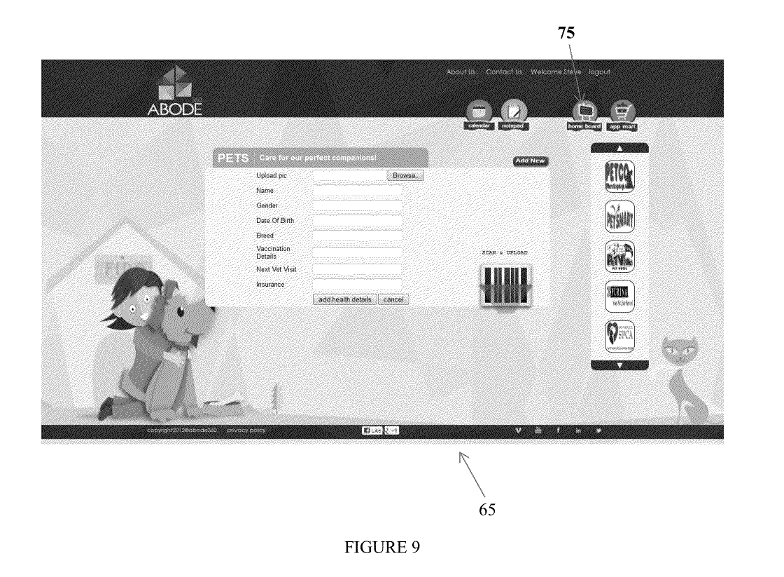

FIG. 9 illustrates an embodiment of a screen 65 for a household pet application, which can be accessed by selecting, e.g., clicking on, a pets icon 20 that may be embedded on the initial home screen 10. The pets application may consolidate information relating to pets for a household unit. Data stored and made available through the pet screen may include: medical conditions for pets, vaccination history, medical documents, RFID tracking chip identification numbers, grooming history, heartworm medication schedule, tick and flea medication schedule, emergency contact information for lost pets, and the like. The system may also be adapted to run applications from third-party pet-supply retailers such as Petsmart® or Petfood® to acquire data from the system for the purpose of providing targeted third-party discounts and quotes for pet supplies and services. Advantageously, the pets application may be adapted to provide an alert for veterinary appointments, grooming, license renewal, and so forth.

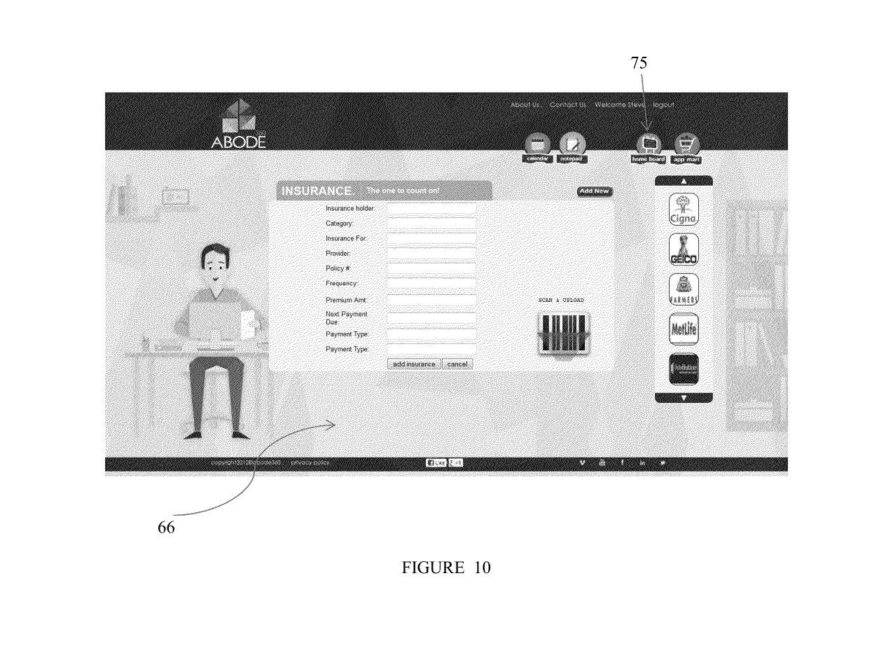

FIG. 10 illustrates an embodiment of a screen 66 for an insurance application, which can be accessed by selecting, e.g., clicking on, an insurance icon 17 that may be embedded on the initial home screen 10. The insurance application may include a list of all household unit policies, e.g., motor vehicle, boat, home, renter's, life, individual health care, and so forth, as well as may consolidate information and details relating to the policies, e.g., policy numbers, policy providers, premium amounts, premium due date(s), payment types, historical claims, status of pending claims, and so forth. These data can be input into the insurance application manually or, optionally, details can be uploaded using a barcode scanner. The system may also be adapted to run applications from third-party insurers to acquire data from the system for the purpose of providing targeted third-party discounts and quotes for insurance needs. Advantageously, the insurance application may be adapted to provide an alert for paying insurance premiums, for conducting an insurance review, and the like.

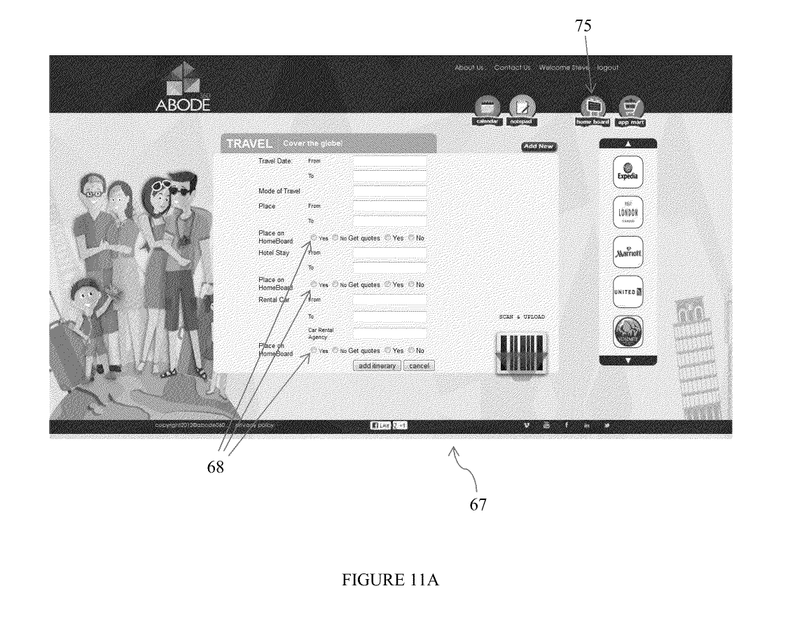

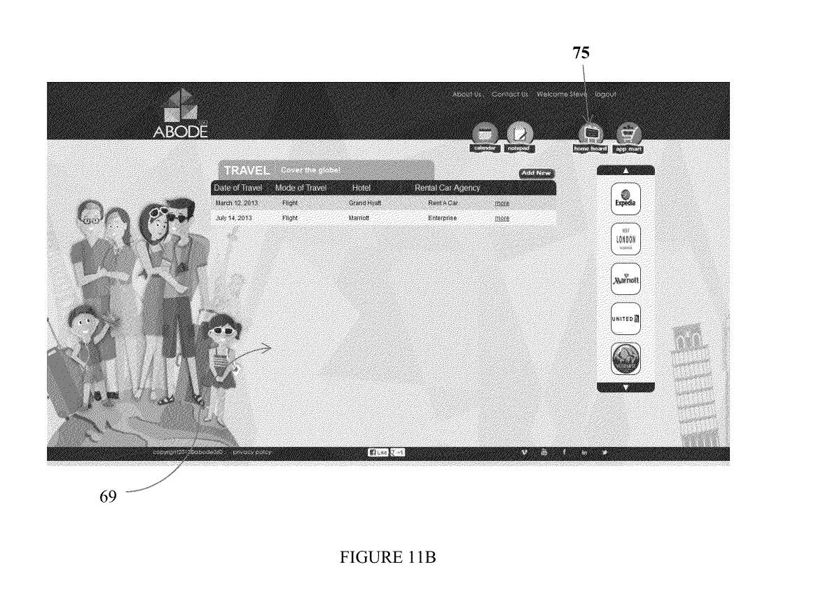

FIG. 11A illustrates an embodiment of a screen 67 for a travel application, which can be accessed by selecting, e.g., clicking on, a travel icon 18 that may be embedded on the initial home screen 10. The travel application may be used to plan individual member and household unit travel plans and itineraries. Members of the household unit may manually enter travel dates, destination, and other information, e.g., mode of travel details, accommodation details, and the like, or, more preferably, members may simply enter travel dates and select a “Place on Home Board” option 68, which will be discussed in greater detail below. Advantageously, by selecting the Home Board option 68, the household unit's travel dates (and, optionally, travel destination) are provided to third-party resort, cruise, airlines, rental car, travel, and other agencies from whom the household unit may receive targeted offers and discounts for a household unit vacation. FIG. 11B illustrates an embodiment of a travel summary screen 69 that may provide, inter alia, date of travel, mode of travel, accommodations, and rental car information.

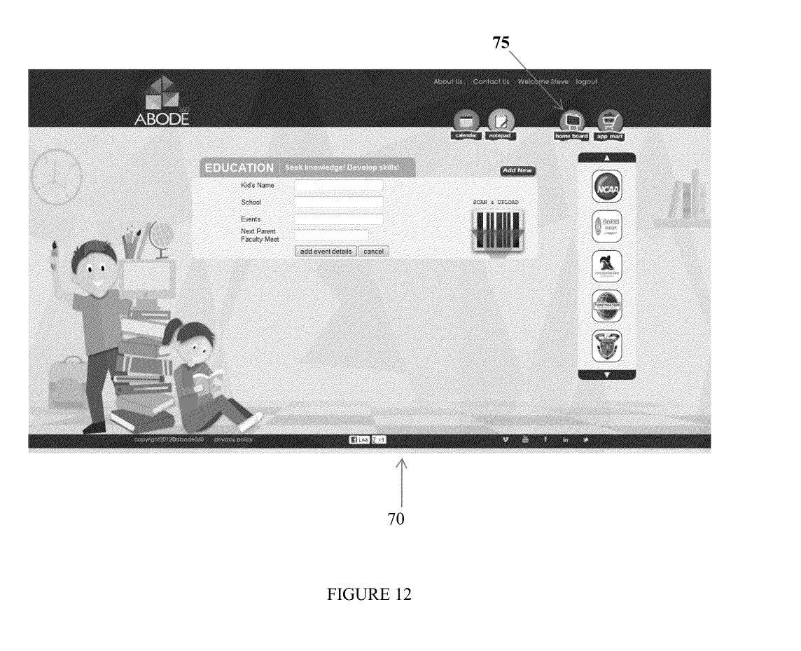

FIG. 12 illustrates an embodiment of a screen 70 for an education application, which can be accessed by selecting, e.g., clicking on, an education icon 21 that may be embedded on the initial home screen 10. Household unit education data, e.g., school, home room teacher, principal, contact information, school hotline numbers, upcoming school events, and the like, can be input into the education application manually or, optionally, details can be uploaded using a barcode scanner. Advantageously, the education application may be adapted to include important dates in the household unit calendar of events and, moreover, to provide an alert for attending PTA meetings, for attending parent's night, for attending sporting and theatrical events, and the like.

The Home Board is one of many novel features of the present invention. Accordingly, a Home Board icon 75 may appear on and/or may be embedded in the initial home screen 10 and all other screens. When a member of the household unit selects, e.g., by clicking on, the Home Board icon 75, a Home Board screen 71 is displayed over the previous screen from which the icon was selected. The Home Board screen 71 may continue to display all household unit plans and/or goals until the goals/plans have been fulfilled or otherwise removed from the list. When the Home Board screen 71 is displayed, the requesting member may manually input a plan or a goal, e.g., purchase a television or a new car, into the Home Board 71. The system, in turn, is adapted to include the plan/goal in an application programming interface (API). A plurality of licensed third-party merchants may call the API for the purpose of providing targeted quotes or discounts that address the stated plan/goal directly. Optionally, these data may also be shared with social circles and/or with retailers who may be able to provide a more competitive quote than the quote from any of the licensed third-party merchants. Advantageously, any targeted quotes or discounts are channeled back through the Home Board 71 and the system rather than through multiple telephone calls, emails, and the like.

### Exemplary Environment and Architecture

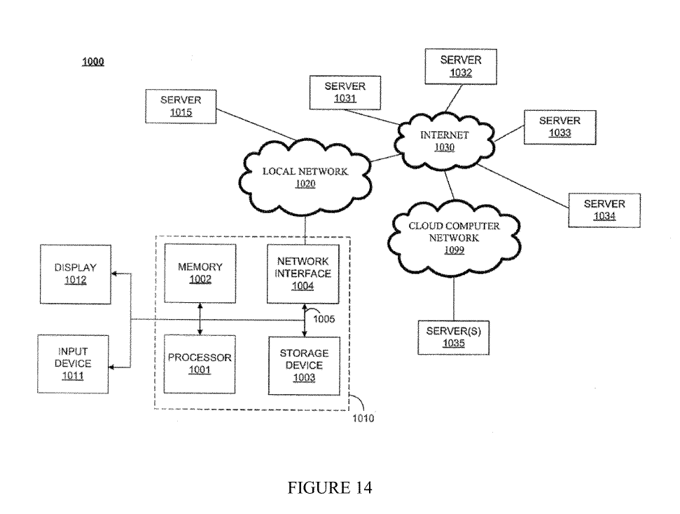

As mentioned above, the computer systems and software servers may be disposed on a local network and may be adapted to communicate with each other and with other computer systems and servers running instances of programs on a cloud computer system. An exemplary computer system 1010 is illustrated in FIG. 14. The computer system 1010 may include a bus 1005 or other communication mechanism for communicating information and signals, and a processor 1001 for processing information. Although a single bus 1005 is shown, in some systems, the bus 1005 may comprise multiple specialized buses. The computer system 1010 also may include a memory 1002, i.e., data storage, coupled to bus 1005 for storing information and instructions to be executed by the processor 1001, including information and instructions for performing the techniques described above. This memory 1002 may also be used for storing variables or other intermediate information during execution of instructions to be executed by the processor 1001. Possible implementations of this memory 1002 may be, but are not limited to, random access memory (RAM), read only memory (ROM), or both. A storage device 1003 is also provided for storing information and instructions. Common forms of storage devices include, for example, a hard drive, a magnetic disk, an optical disk, a CD-ROM, a DVD, a flash memory, a USB memory card, or any other medium from which a computer can read. The storage device 1003 may include source code, binary code or software files for performing the techniques above, for example. Storage device 1003 and memory 1002 are both examples of computer readable mediums.

The computer system 1010 may be coupled, e.g., via the bus 1005, to a display device 1012, such as a cathode ray tube (CRT) or liquid crystal display (LCD), for displaying information to a computer user. An input device 1011, e.g., a keyboard, a mouse, and the like, may be coupled to bus 1005 for communicating information and command selections from the user to the processor 1001. The combination of these components allows the user to communicate with the system 1000.

The computer system 1010 also includes a network interface 1004 that is coupled with bus 1005. The network interface 1004, e.g., a digital subscriber line (DSL) or a modem to provide data communication connection over a telephone line, may provide two-way data communication between the computer system 1010 and the local network 1020. Another example of a network interface 1004 is a local area network (LAN) card to provide a data communication connection to a compatible LAN. Wireless links are yet another example. In any such implementation, the network interface 1004 sends and receives electrical, electromagnetic, and/or optical signals that carry digital data streams representing various types of information.

The computer system 1010 may be adapted to send and receive information, including messages or other interface actions, e.g., through the network interface 1004, across a local network 1020, an Intranet, and/or the Internet 1030. When networked to a local network 1020, the computer system 1010 may communicate with a plurality of other computer machines, such as a server 1015, one or more of which may run backend system software, e.g., an ERP software system, CRM, or database. Accordingly, the computer system 1010 and server computer systems represented by server 1015 may form a local network, which may be programmed with processes described herein.

When networked via the Internet 1030, software components or services executing on a computer system 1010 in the local network may communicate with computer programs on a cloud network 1099 across the Internet. Communications with computer programs on the Internet 1030 may include communication with programs residing on multiple different computer systems 1010 or servers 1031-1035 across the network. The processes described above may be implemented for communication with programs implemented on one or more servers 1031-1035, for example. A server 1035 residing on cloud 1099, for example, may transmit messages to a component on computer system 1010, e.g., via Internet 1030, local network 1020, and network interface 1004. The software components and processes described above may be implemented on any computer system and may transmit and/or receive information between networks as set forth above.

The system 1000 depicted in FIG. 14 may be configured to implement the software platform as operating totally on the “Cloud” 1099. Preferably, the entire platform of the system 1000 would operate on the cloud 1099. All home-related data, personal information of the individual members of the household unit, their activities, data related to all assets, pets, etc., may be stored, accessed, and retrieved from the cloud 1099. Indeed, as long as there is an Internet connection, which may be made available through Cable networks, DSL or Wireless networks, the system platform could be accessed through any one or more of mobile devices, smartphones, tablets, PCs, laptops, and/or television sets, any of which may be represented by the computer system 1010.

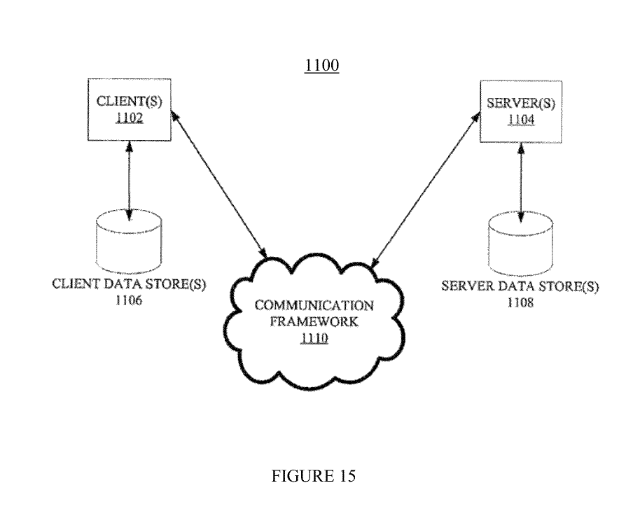

Referring to FIG. 15, a block diagram of an embodiment of a simple computing environment 1100 that can be utilized to implement some embodiments is shown. The diagram illustrates a system that includes one or more clients 1102 and one or more servers 1104. The client(s) 1102 can be implemented as hardware, software, e.g., threads, processes, computing devices, or a combination of hardware and software. The server(s) 1104 can also be implemented as hardware, software, e.g., threads, processes, computing devices, or a combination of hardware and software. One possible communication between a client 1102 and a server 1104 may be in the form of a data packet adapted to be transmitted between two or more computer processes. The system 1100 includes a communication framework 1110 that may be employed to facilitate communications between the clients(s) 1102 and the server(s) 1104. The client(s) 1102 may be connected to one or more client data store(s) 1106 that can be employed to store information local to the client(s) 1102. Similarly, the server(s) 1104 may be connected to one or more server data store(s) 1108 that can be employed to store information local to the server(s) 1104. In some embodiments, system 1100 can be include and/or be utilized by the various systems and/or methods described herein to implement the processes described herein.

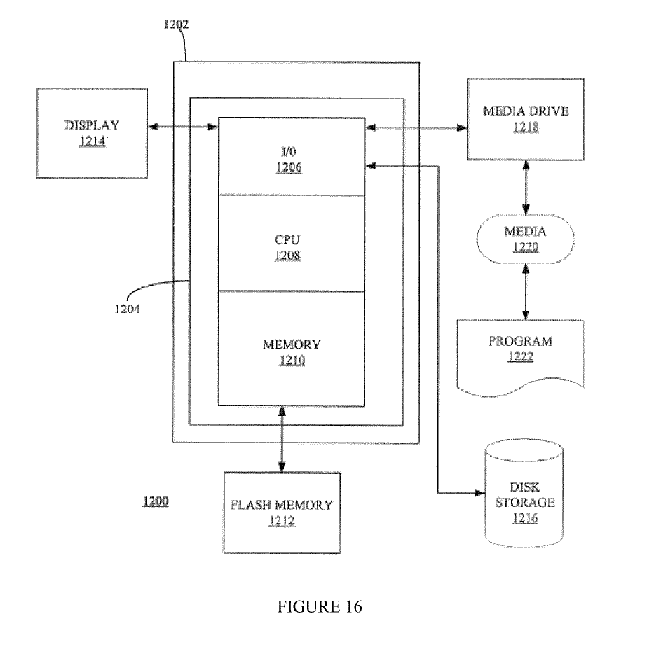

FIG. 16 depicts an exemplary computing system 1200 that can be configured to perform any one of the processes provided herein. In this context, computing system 1200 may include, for example, a processor, memory, storage, and I/O devices, e.g., monitor, keyboard, disk drive, Internet connection, and so forth. However, computing system 1200 may include circuitry or other specialized hardware for carrying out some or all aspects of the processes. In some operational settings, computing system 1200 may be configured as a system that includes one or more units, each of which is configured to carry out some aspects of the processes either in software, hardware, or some combination thereof.

The main system 1202 of the computing system 1200 includes a motherboard 1204 having an I/O section 1206, one or more central processing units (CPU) 1208, and a memory section 1210, which may have a flash memory card 1212 related to it. The I/O section 1206 may be connected to a display 1214, a keyboard and/or other user input (not shown), a disk storage unit 1216, and a media drive unit 1218. The media drive unit 1218 may read/write a computer-readable medium 1220, which can contain programs 1222 and/or data. The computing system 1200 may include a Web browser (not shown). Moreover, it is noted that computing system 1200 may be configured to include additional systems in order to fulfill various functionalities.

At least some values based on the results of the above-described processes can be saved for subsequent use. Additionally, a computer-readable medium can be used to store, i.e., tangibly embody, one or more computer programs for performing any one of the above-described processes by means of a computer. The computer program may be written, for example, in a general-purpose programming language, e.g., Pascal, C, C++, Java, Python, and the like, or some specialized application-specific language, e.g., PHP, Java Script, and the like.

### Exemplary Process

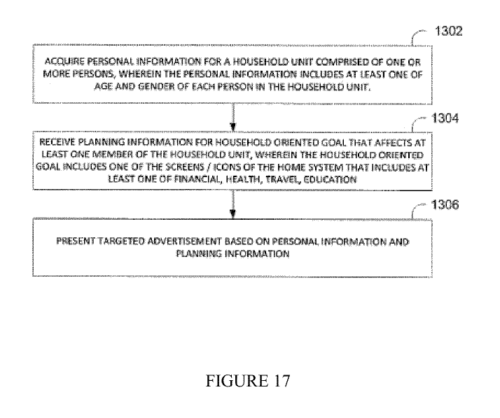

FIG. 17 shows a flow chart illustrating an exemplary process for presentation of a targeted advertisement to a member of the household unit. The process is based on personal information and planning information. In operation 1302, the system acquires personal information for a household unit comprised of one or more persons, wherein the personal information includes at least one of age and gender of each person in the household unit. The system may include the computing system 1010, at least one server 1031, 1032, 1033, 1034, 1035, the client 1102, the server 1104, and/or the computing system 1200.

The system may acquire the personal information for the household when a user inputs the data such as by selection of a menu choice or direct entry in a data field. Alternatively or in addition, the system may acquire the personal information from any of the client data store 1106, the server data store 1108, the communication framework 1110, the media drive 1218, the media 1220, the disk storage 1216, the memory 1210, and/or the flash memory 1212. The personal information that includes at least one of age and gender for each person in the household may in other embodiments includes more or less information. For example, the personal information may include a person's image, financial information, medical history, current electronic equipment owned, etc. The one or more persons for the household unit may be a family member(s), such as parent and child, married spouses or siblings. Alternatively, the one or more person of the household unit may have another relationship, such as friendship, a teammate, a business relationship or an association in which the two persons are willing to have their personal data shared in some way with at least one other member of the household unit.

In operation 1304, the system may receive planning information for a household-oriented goal that affects at least one member of the household unit, wherein the household-oriented goal includes at least one of the screens/icons 14 disposed on the home screen 10. The planning information may be received from user input and/or from a third party's system, such as a social network or financial planning site. In addition, the planning information may be acquired from the computing system 1010, the server(s) 1031, 1032, 1033, 1034, 1035, the client data store 1106, the server data store 1108, the communication framework 1110, the media drive 1218, the media 1220, the disk storage 1216, the memory 1210, and/or the flash memory 1212.

The household-oriented goal may include different information in other embodiments. As described in operation 1304, the household-oriented goal includes at least one of vacation, retirement, or education. The goal may include a destination, a target amount to save, a particular item to purchase, a debt payoff, a date for travel, and so forth. The goal may affect multiple members of the household unit, whether because multiple persons are involved in traveling, retiring or obtaining additional education, and/or because shared resources are used to accomplish the goal, and/or because the involvement of one person will affect his/her availability for other activities for the household unit. In other embodiments, the household-oriented goal may be unrelated to vacation, retirement or education, and may involve, instead, another event that impacts the household unit in some way.

In operation 1306, the system presents a targeted advertisement based on the personal information and the planning information. The system may use the CPU 1208, the computing system 1010, the server(s) 1031, 1032, 1033, 1034, 1035, the client 1102, and/or the server 1104 to process an algorithm, driver programs, application, and the like, e.g., based on software stored in the memory 1210, the media 1220, and/or the flash memory 1210, to determine which advertisement to present.

The algorithm, driver program, application, and the like may include consideration of the demographic to which the personal information of one or more members of the household may be associated with, which may be indicated by the personal information. For example, the age and gender of one or more of the persons in the household unit may indicate that the person is part of the baby boomer generation, which may have access to greater wealth and resources than a younger, e.g., Generation X, person who recently started his/her career. In addition, the gender of a person making a decision may indicate what will be purchased, such as a type of car, or a television model with greater resolution, 3D capability, or surround sound. In addition, the collective combination of personal information for the one or more persons in the household unit may indicate that a different decision may be made than if just one person were making a decision. For example, a married couple may choose a vacation destination such as a cruise, or a tropical resort, whereas a group of friends may choose a singles travel group or a destination with adventure sports. Recorded, historical behavior may also be a factor; hence, prior choices may be stored by the system for future reference as part of the determination of what advertisement to present.

The algorithm, driver program, application, and the like may further include consideration of the planning information. For example, the members of the household unit may have selected a destination that may affect the hotels, travel agencies, and/or tour groups that may wish to present advertisements to the household unit. The planning information may include a date of travel, which may affect hotel and/or flight availability. The planning information may involve saving for a particular amount, which may require achievement of a particular rate of return, such as from a bank account and/or investments, which may affect whether tax or financial advice may be relevant for the household unit. The planning information may involve a particular degree or a school to attend, which may indicate that one or more of the persons in the household unit would be interested in part-time or full-time employment in the area associated with the school, that rental residences may be needed, and/or that a restaurant or hotel in the area may be useful for a visit to the location.

Although the present embodiments have been described with reference to specific examples, various modifications and changes can be made to these embodiments without departing from the broader spirit and scope of the invention. For example, the various devices, modules, etc. described herein can be enabled and operated using hardware circuitry, firmware, software or any combination of hardware, firmware, and software, e.g., embodied in a machine-readable medium.

In addition, it will be appreciated that the various operations, processes, and methods disclosed herein can be embodied in a machine-readable medium and/or a machine accessible medium compatible with a data processing system, e.g., a computer system, and can be performed in any order, e.g., including using means for achieving the various operations. Accordingly, the specification and drawings are to be regarded in an illustrative rather than in a restrictive sense. In some embodiments, the machine-readable medium can be a non-transitory form of machine-readable medium.

What we claim is:

1. A system for household organization, comprising:
at least one computer memory for storing computer executable instructions; and
at least one processor for executing the instructions, wherein execution of the instructions causes a software platform to collect, store in the computer memory, and use information about members of the household and about a plurality of individual and group activities of the members of the household to establish at least one of a household plan or a household goal,
the software platform adapted to share data and content associated with each household plan and household goal with a third party in order to solicit targeted quotes from the third party to accomplish each household plan and household goal.

2. The system of claim 1, wherein the information about members of the household includes at least one of a relationship between members, age, gender, an education level, a type of employment, personal income, savings, investments, health insurance, life insurance, automobile insurance, home insurance, rental insurance, personal and real property ownership, recent transactions completed, recent online searches performed, or a wish list of items to purchase.

3. The system of claim 1, wherein the information about the plurality of individual and group activities is selected from the group consisting of a to-do chore list, a calendar of events, a personal calendar, a text message, and an email message.

4. The system of claim 1, wherein access to the information is restricted to only discrete, pre-defined users.

5. The system of claim 1, wherein the system is accessible by a mobile device belonging to any of the members of the household.

6. The system of claim 1, wherein the software platform includes at least one application to track an item that is selected from the group consisting of:
health and medical history of a member of the household;
a health care provider of a member of the household;
recurring prescription needs of a member of the household;
education of a member of the household;
financial planning of a member of the household;
estate planning of a member of the household;
insurance information of a member of the household;
insurance information of assets in the household;
warranty information of assets in the household;
maintenance services planning and scheduling within the household for at least one of gardening, house cleaning, duct cleaning, chimney cleaning, servicing of heating, servicing of air-conditioning, plumbing, electric, garage door opener, water softener, water heater, and fans;
savings information of a member of the household;
investment information of a member of the household;
travel planning of a member of the household;
vacation planning of a member of the household;
shopping preferences of a member of the household;
periodic billing creditors of a member of the household;
household resource planning;
household social networking; and
a list of household chores, including assignment of each chore to a member of the household.

7. The system of claim 1, wherein the third-party is an advertiser that transmits target-specific advertisements to the members of the household in furtherance of each household plan and household goal.

8. The system of claim 1, wherein the software platform includes artificial intelligence to identify spending patterns of members of the household.

9. The system of claim 1, wherein the software platform includes artificial intelligence to identify an opportunity to refinance at least one of a home mortgage loan, a home equity loan, a business loan, or an automobile loan.

10. The system of claim 1, wherein the software platform is further adapted to collect, store in the computer memory, and use information about electronic devices and appliances within the household.

11. The system of claim 1 further comprising a scanning device for uploading a receipt of a purchase into the system.

12. A method of organizing and managing a household unit using a communications network, the method comprising:
acquiring, and thereafter storing in a computer memory, information from a plurality of members of a household;
acquiring, and thereafter storing in the computer memory, planning information for establishing at least one of a household plan or a household goal; and
sharing, with a third party via the network, data and content associated with each household plan and household goal in order to solicit targeted quotes from the third party to accomplish each household plan and household goal.

13. The method of claim 12 further comprising presenting third-party advertisements to at least one member of the household based on the information from the plurality of members of the household and on the planning information.

14. The method of claim 12 further comprising receiving operational information from a plurality of electronic devices and appliances that are adapted to communicate said operational information via the network.

15. The method of claim 14, wherein the operational information received comprises at least one item selected from the group consisting of a usage, a readiness, a charge status, a usable life, diagnostic information, and an expected remaining usable life.

16. The method of claim 12 further comprising restricting access to the information from the plurality of members of the household.

17. The method of claim 12 wherein acquiring the information from the plurality of members of the household comprises importing information from a non-member of the household.

18. The method of claim 12 wherein acquiring the information from the plurality of members of the household comprises scanning a receipt document and uploading the scanned receipt document information.

19. An article of manufacture for use in a system for household organization, the article of manufacture comprising computer-readable program portions embedded thereon for organizing the household, the program portions comprising instructions for:
acquiring, and thereafter storing in a computer memory, information from a plurality of members of a household;
acquiring, and thereafter storing in the computer memory, planning information for establishing at least one of a household plan or a household goal; and
sharing, with a third party via a network, data and content associated with each household plan and household goal in order to solicit targeted quotes from the third party to accomplish each household plan and household goal.

20. The article of manufacture of claim 19 further comprising instructions for presenting third-party advertisements to at least one member of the household based on the information from the plurality of members of the household and on the planning information.
